(19) United States
(12) Patent Application Publication
(10) Pub. No.: US 2026/0161496 A1
(43) Pub. Date: Jun. 11, 2026

(54) METHOD AND SYSTEM FOR LEARNING AND INFERENCING FAULTS

(71) Applicant: Telefonaktiebolaget LM Ericsson (publ), Stockholm (SE)

(72) Inventors: Chunyan FU, Pointe-Claire (CA); Behshid SHAYESTEH, Montreal (CA); Amin EBRAHIMZADEH, LaSalle (CA); Roch GLITHO, Ville Saint Laurent (CA)

(73) Assignee: Telefonaktiebolaget LM Ericsson (publ), Stockholm (SE)

(21) Appl. No.: 18/706,371

(22) PCT Filed: Nov. 29, 2021
(86) PCT No.: PCT/IB2021/061085

§ 371 Date: Apr. 30, 2024

(51) Int. Cl. G06F 11/07

(52) U.S. Cl. CPC G06F 11/079; G06N 3/0895

(57) ABSTRACT

A method and system for identifying and handling new fault types is provided where the method includes receiving a new set of data samples related to a new fault, training a new model for the new fault using the new set of data samples, comparing the new set of data samples against a set of previously collected data samples, and storing the new model in an episodic model store, in response to a similarity of the new set of data samples and the set of previously collected data samples failing to meet a first threshold level of similarity.

### TECHNICAL FIELD

Embodiments relate to the field of fault management; and more specifically, to a method and system for learning and inferencing faults.

### BACKGROUND ART

Machine learning (ML) algorithms can be deployed in many operating environments. For example, ML algorithms can be deployed in telecommunication networks for various purposes including managing the operations of the telecommunications networks. In some cases, ML algorithms can be deployed at the ‘edge’ of these telecommunication networks. The computing resources at the edge (e.g., at base stations) can be limited. The operation of edge devices and other operating environments are often affected by the detection and handling of faults in these operating environments. Due to the complexity of these operating environments and the large number of applications, tasks, and data sets that these operating environments manage, the proper operation and uptime of these operating environments has a tremendous impact on the users, organizations, and other entities that utilize the operating environments.

The management of these operating environments can be at least partially based on fault management. A ‘fault’ is an indicator of an issue (e.g., hardware or software constraint or failure) in the operating environments. Fault management can include identifying and attempting to remedy the faults in the operating environments. Faults can be based on any variety of monitored metrics or similar measurements of the operation of the hardware and software in the operating environment. When the monitored metrics are determined to be outside a normal operating range then a ‘fault’ can be generated to notify administrators or management software that a failure or issue has been detected that may need to be resolved for the continued proper operation of the operating environment.

### SUMMARY

In one embodiment, a method and system to identify and handle new fault types is provided where the method includes receiving a new set of data samples related to a new fault, training a new model for the new fault using the new set of data samples, comparing the new set of data samples against a set of previously collected data samples, and storing the new model in an episodic model store, in response to a similarity of the new set of data samples and each of the set of collected data samples failing to meet a first threshold level of similarity.

In a further embodiment, a non-transitory machine-readable storage medium provides instructions that, if executed by a processor, will cause the processor to perform operations including receiving a new set of data samples related to a new fault, training a new model for the new fault using the new set of data samples, comparing the new set of data samples against a set of previously collected data samples, and storing the new model in an episodic model store, in response to a similarity of the new set of data samples and each of the set of collected data samples failing to meet a first threshold level of similarity.

In another embodiment, an electronic device includes a non-transitory machine-readable medium having stored therein a fault manager, and a set of processors coupled to the non-transitory machine-readable medium, the set of processors to execute the fault manager, the fault manager to receive a new set of data samples related to a new fault, train a new model for the new fault using the new set of data samples, compare the new set of data samples against a set of previously collected data samples, and store the new model in an episodic model store, in response to a similarity of the new set of data samples and each of the set of collected data samples failing to meet a first threshold level of similarity.

### BRIEF DESCRIPTION OF THE DRAWINGS

The embodiments may best be understood by referring to the following description and accompanying drawings that are used to illustrate embodiments. In the drawings:

FIG. 1 is a diagram of one embodiment of a complementary learning system.

FIG. 2 is a diagram of one embodiment of a fault management system.

FIG. 3 is a flowchart of one embodiment of a process for new fault detection.

FIG. 4 is a diagram of one embodiment of a fault learning system.

FIG. 5 is a flowchart of one embodiment of a process of a fault learning system.

FIG. 6 is diagram of one embodiment of a fault classification system.

FIG. 7 is a flowchart of one embodiment of a process for fault replay.

FIG. 8 is a flowchart of one embodiment of a process for retraining and testing a fault classifier.

FIG. 9 is a flowchart of one embodiment of a process for a fault prediction model update.

FIG. 10 is a diagram of one embodiment of a fault inferencing system.

FIG. 11 is a flowchart of one embodiment of a process for fault inferencing.

FIG. 12A illustrates connectivity between network devices (NDs) within an exemplary network, as well as three exemplary implementations of the NDs, according to some embodiments.

FIG. 12B illustrates an exemplary way to implement a special-purpose network device according to some embodiments.

FIG. 12C illustrates various exemplary ways in which virtual network elements (VNEs) may be coupled according to some embodiments.

FIG. 12D illustrates a network with a single network element (NE) on each of the NDs, and within this straightforward approach contrasts a traditional distributed approach (commonly used by traditional routers) with a centralized approach for maintaining reachability and forwarding information (also called network control), according to some embodiments.

FIG. 12E illustrates the simple case of where each of the NDs implements a single NE, but a centralized control plane has abstracted multiple of the NEs in different NDs into (to represent) a single NE in one of the virtual network(s), according to some embodiments.

FIG. 12F illustrates a case where multiple VNEs are implemented on different NDs and are coupled to each other, and where a centralized control plane has abstracted these multiple VNEs such that they appear as a single VNE within one of the virtual networks, according to some embodiments.

FIG. 13 illustrates a general purpose control plane device with centralized control plane (CCP) software 1350), according to some embodiments.

### DETAILED DESCRIPTION

The following description describes methods and apparatus for identifying and classifying a new fault that is detected by a fault management system. The embodiments are examples of a fault management system that is based on complementary learning process and system. The embodiments define a system that learns a fault when it is first detected by the fault management system, classifies the fault, and trains models for fault detection and prediction (i.e., inference). The fault management system includes a fault learning system (FLS) that learns a new fault when a new fault detector component detects an unmanaged fault. A fault classification system (FCS) classifies the new fault, and trains and stores the models that can detect and predict the new fault, as a fault inferencing system (FIS) that detects or predicts the faults online. The embodiments can also define a method that applies the fault management system to large-scale, heterogeneous edge cloud environments.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the embodiments. It will be appreciated, however, by one skilled in the art that the embodiments may be practiced without such specific details. In other instances, control structures, gate level circuits and full software instruction sequences have not been shown in detail in order not to obscure the embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Faults often occur in operating environments (e.g., edge cloud environments) and it is not an easy task to manage faults in operating environment due to the scale, heterogeneity, and dynamicity of many operating environments such as edge computing environments. Automating fault management is an important steppingstone towards the self-management/zero-touch vision of 5th Generation (5G) standards and future planned standards. Artificial intelligence (AI) and machine-learning (ML) are key enabling technologies for automation.

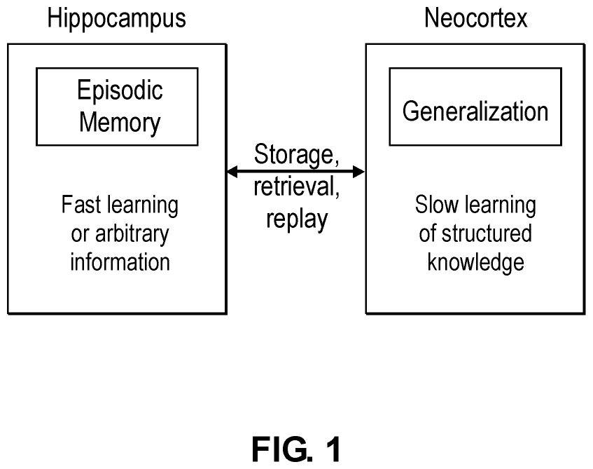

FIG. 1 is a diagram of one embodiment of a complimentary learning system. In some embodiments, anomaly detection is used for fault detection, where, for example, a Gaussian model is trained using normal data and the outliers can be seen as anomalies. This method is unsupervised and does not need data labeling. However, this method can only detect an outlier, without being able to determine if the outlier is a system failure or not, nor can this process help the operator determine the type of the failure, which is also important for fault management.

Supervised learning is also used for fault detection and prediction. Some example supervised learning models are trained using labeled fault and non-fault data. In this way, the model can detect and tell the class of a fault when a fault is detected and when a fault is recurrent or cumulative. Trained time-series prediction models can predict the fault. The limitation of this method is that this method does need labels which involves partial or full human intervention.

In some embodiments, a complementary learning systems (CLS) is utilized in the fault management system. The CLS theory defines the complementary contribution of the ‘hippocampus’ and the ‘neocortex’ components, modeled after the human brain, in learning and memory, suggesting that there are specialized mechanisms in the human cognitive system for protecting consolidated knowledge. The hippocampal system (i.e., the Episodic Memory) exhibits short-term adaptation and allows for the rapid learning of new information which will, in turn, be transferred and integrated into the neocortical system (i.e., the Semantic Memory) for its long-term storage. The neocortex is characterized by a slow learning rate and is responsible for learning generalities.

Existing machine learning-based fault detection and prediction systems can detect the anomalies of a system without knowing if the anomalies are caused by a fault. In cases where anomalies are caused by a fault, the machine learning based fault detection and prediction systems cannot determine, which type of fault caused the anomaly. Instead, the determination of the type of fault requires human intervention to label the fault and non-fault data and train model(s) with such data. Existing supervised learning methods do not automatically learn new faults. These methods require manual retraining of models or training new models for each type of new fault.

The embodiments overcome these aspects of existing fault management systems by incorporating a complementary learning system. The embodiments define a system that learns a fault when it occurs, classifies the fault and trains models for fault detection and prediction. The embodiments include a Fault Learning System (FLS) that learns a new fault when the new fault detector detects an unmanaged fault, a Fault Classification System (FCS) that classifies the fault, and trains and stores the models that can detect and predict the fault, and a Fault Inferencing System (FIS) that detects or predicts the faults online. The embodiments also defines a method that applies the system to large-scale, heterogeneous edge cloud environments.

The embodiments have advantages over existing fault detection and prediction systems, where the illustrated methods do not require human intervention for learning new faults. The fault management system learns new faults without forgetting previously identified faults. The embodiments provide a method that gradually builds on up a knowledge of faults and adjusts the knowledge based on the feedback from the environment. This process provides a more accurate fault inferencing system over time. The method is general enough to adapt to various types of faults that occur in different operating environments such as in heterogenous edge cloud environments. The embodiments also enable easier knowledge sharing among fault management system instances in different operating environments such as in different edge sites by transferring the semantic memory of faults from one fault management instance to another fault management instance.

The embodiments provide a fault management system that can be deployed to many types of operating environments. Example deployments to edge cloud system are provided by way of illustration and not by way of limitation. One skilled in the art would understand that the fault management system described by example in the context of an edge cloud system in a telecommunication network can be applied to other operating environments such as general cloud computing systems, data centers, and similar operating environments. The example edge cloud systems described herein are part of a distributed system including multiple connected edge sites, each site being monitored by a monitoring system which collects the software and hardware related metrics data. Examples of such monitoring systems include Prometheus, by SoundCloud and Metricbeat, by Elastic.

The embodiments define a continuous learning and inferencing system utilizing CLS, which is a proven theory of continual learning. The embodiments apply CLS to time series data (i.e., metrics from a monitored system), to improve the operation of a fault management system, where the fault management system attempts to continuously learn new faults that occur in an operating environment such as an edge cloud system. The fault management system classifies the faults, builds knowledge of faults, trains a model for each classification of faults, and inferences the faults as they occur, are detected, or are reported. The embodiments can utilize deep learning models for building episodic and semantic memories so that new faults are learned and managed without ‘forgetting’ the knowledge of how to recognize and handle previously identified faults.

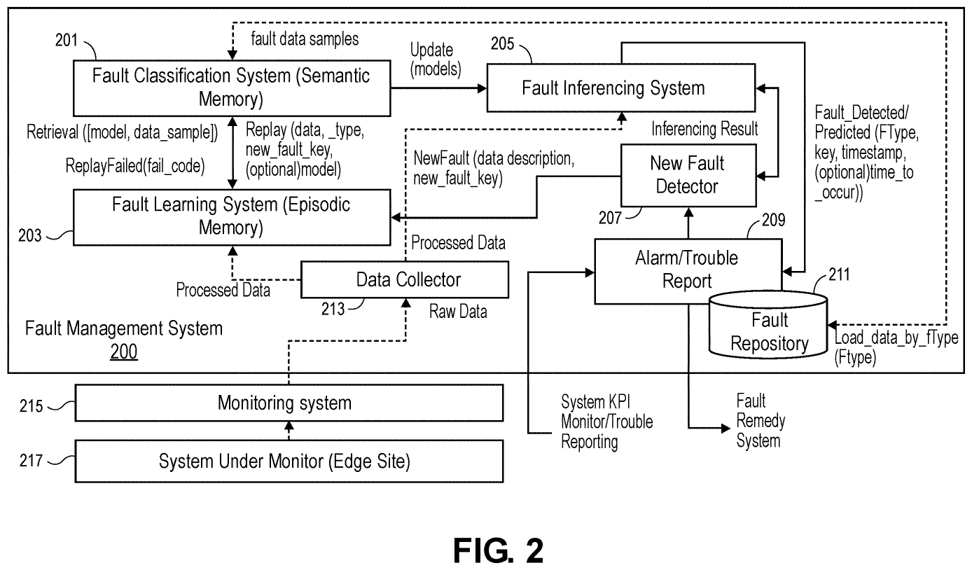

FIG. 2 is a diagram of one embodiment of an operating environment for a fault management system and the associated components for servicing the given operating environment. The operating environment includes the fault management system 200, a monitoring system 215, and a system that is being monitored (i.e., a ‘system under monitor’). The operating environment can be supported by any combination of hardware and software systems that enable the execution of the fault management system 200, monitoring system 215, and system under monitor 217. The hardware and software can be compute, storage, and related resources that store the necessary code and data, execute the code, and provide intercommunication for the components.

The monitoring system 215 can be any set of functions, software, and supporting hardware that enable the collection of metrics related to the operation of the system under monitor 217. The monitoring system 215 can include components that are local to or integrated with the system under monitor 217 as well as components that are remote from the system under monitor 217. The monitoring system 215 can similarly include components that are local to the fault management system 200 or remote therefrom. Example monitoring systems 215 can include Prometheus by Soundcloud, Metricbeats, by Elastic, and similar monitoring systems.

The system under monitor 217 can be any system such as the example edge cloud site. The example edge cloud site can include the hardware and software components at an edge cloud site (e.g., at a base station) or in proximity thereof. The monitoring system 215 can collect any number and variety of metrics for the system under monitor 217. Administrators can identify key performance indicators (KPIs) and similar metrics to be collected and reported to the fault management system 200.

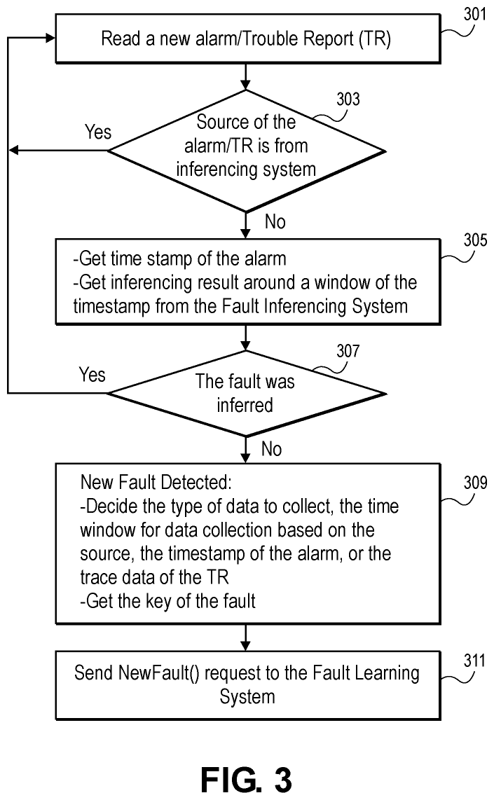

The fault management system 200 can include a fault classification system (FCS) 201, fault learning system (FLS) 203, data collector 213, fault inferencing system 205, new fault detector 207, alarm/trouble report mechanism 209, fault repository 211, and similar components. The new fault detector 207 detects new faults by comparing the fault inferencing results from the fault inferencing system 205 and alarms issued, and/or the trouble reports generated by the alarm/trouble report mechanism 209. When a new fault detected, the new fault detector 207 sends information related to the fault to the FLS 203, which is responsible for learning how to manage the new fault. The operation of the new fault detector is described further herein with regard to FIG. 3.

The alarm and trouble report (TR) mechanism 209 can generate alarms and reports based on information generated by multiple sources. The fault inferencing system 205, can identify previously identified types or classes of faults, where the fault detection is reported to the TR mechanism 209 such that the fault type, timestamp, key, predicted occurrence time, and similar information can be provided by the fault inferencing system 205. Alarms and trouble reports can also be generated and provided to the TR mechanism 209 by the monitoring system 215 and similar components (e.g., a KPI monitor) that can identify and send reports and alarms when an acceptable range of a KPI or similar metric is violated. Other information that is sent to the TR mechanism 209 can include a system failure trouble report created by an administrator and similar reports. The alarms or trouble reports, and their relative data is stored in the fault repository 211, which serves as a data storage for all the historical faults that have occurred in relation to the system under monitor 217. The data in the fault repository 211 can have any format or organization. The data that is stored in the fault repository 211 can be normalized and organized into a log, table, or similar data structure or database to facilitate analysis by the TR mechanism 209 and other components of the fault management system 200.

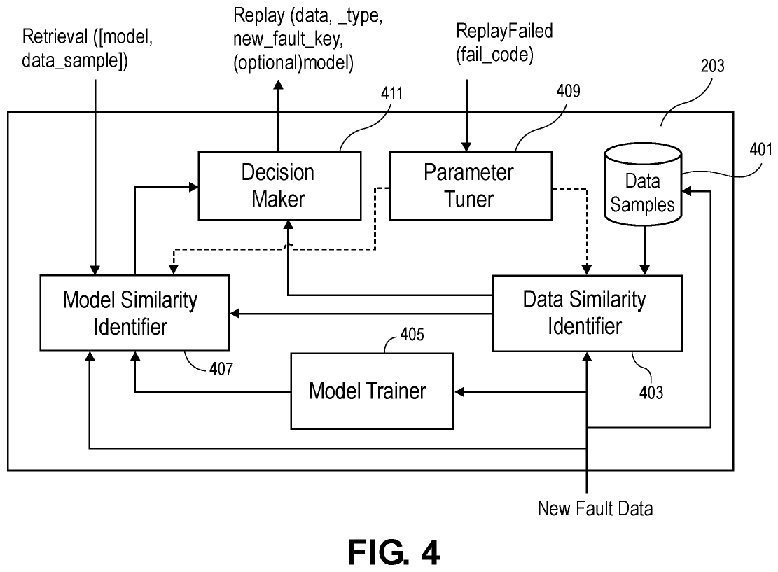

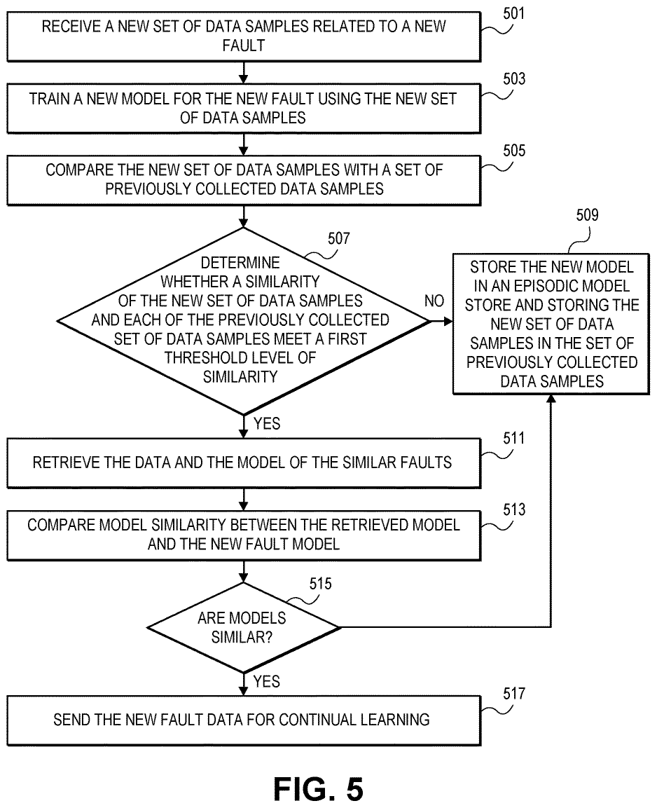

The FLS 203 ‘learns’ a new fault via training a short-term (e.g., episodic memory) model using the data related to the new fault in response to identification and notification of the new fault by the new fault detector 207. The data related to the new fault is collected by the data collector 213 which collects the data from the monitoring system 215. In some embodiments, the data collector 213 pre-processes the data based on configuration or similar requirements set by an administrator or similar entity. The pre-processing of the data organizes the data to facilitate training of the model for the new fault. The FLS 203 also retrieves models from the fault classification system (FCS) 201, makes comparisons between the retrieved models and a model trained for the new fault, identifies the type of the new fault and replays the new fault to the FCS 201. The FLS 201 makes requests for retrieval of models from the FCS 201, requests updates (e.g., ‘replays’) to existing models, and similar functions in response to the notifications from the new fault detector 207. The process of the FLS 203 is further described herein with regard to FIGS. 4 and 5.

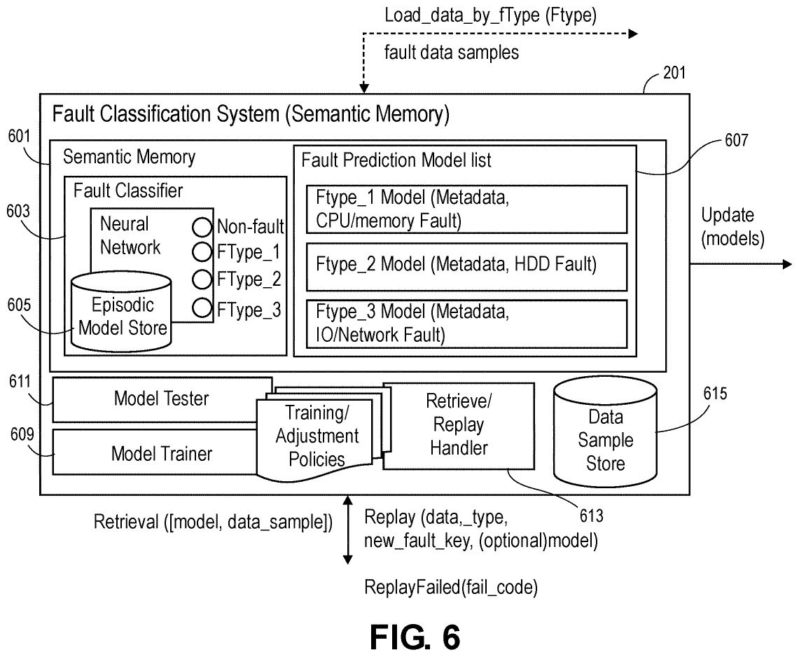

The FCS 201 classifies the faults, trains machine learning models (e.g., neural networks) to detect and predict a type of faults and saves the models along with their metadata as long-term ‘semantic memory.’ The semantic memory is the collection of models for the classes of faults identified. The FCS 201 also updates the models in fault inferencing system 205 when there is a change in the semantic memory (i.e., a change in the models assigned to each class/type of fault). The process of the FCS 201 is further discussed herein with regard to FIGS. 6-9.

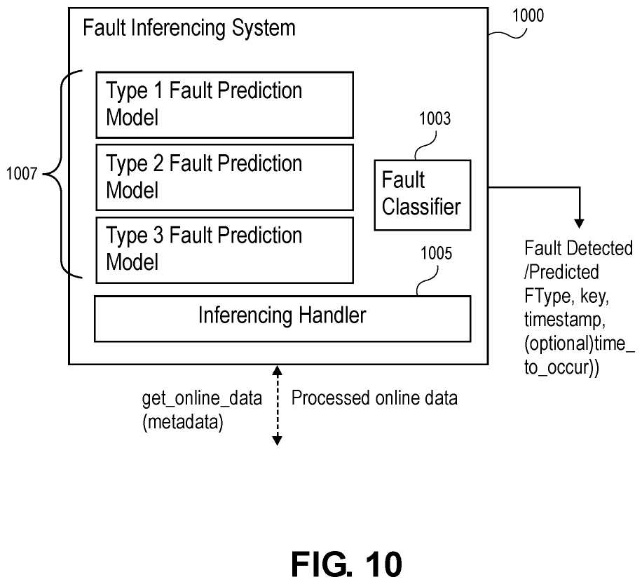

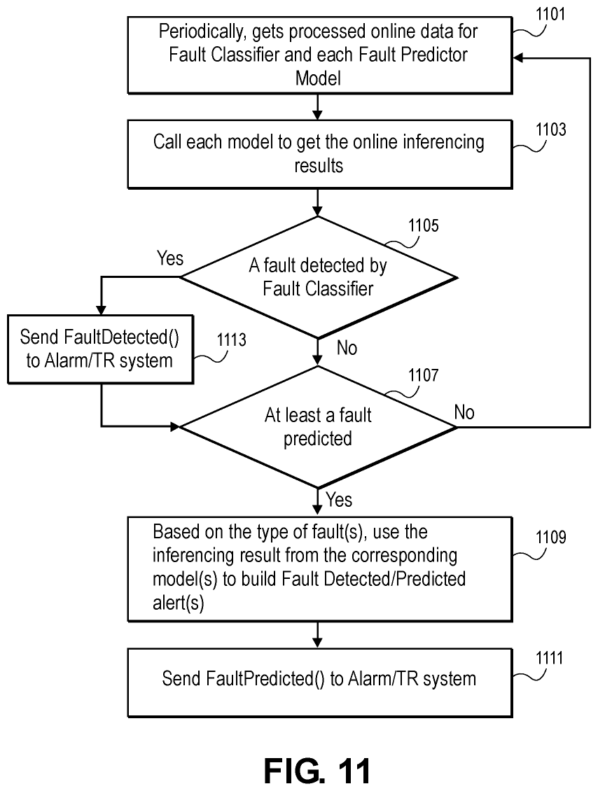

The fault inferencing system 205 applies a number of machine learning models that can detect or predict the faults that occur in the system under monitor 217 based on information reported by the monitoring system 215 and collected by the data collector 213. Once a fault is detected or predicted by application of the machine learning models to the collected data, a message or similar indicator is sent to TR mechanism 209, which may trigger some remedial actions, by a fault remedy system. The fault management system 200 can operate in conjunction with any fault remedy system by providing notifications of the type/class, occurrence, and related information about each detected fault in the system under monitor 217. The results from the fault inferencing system 205 are also sent to the new fault detector 207 which, based on the received results, detects whether there is a new type of fault that has occurred in the system under monitor 217. The fault inferencing system 205 is further described herein with reference to FIGS. 10 and 11.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

The components of the fault management system are provided by way of example and not limitation. One skilled in the art would appreciate that the functions and components of the fault management system can be differently combined, separated, or arranged consistent with the principles as described herein.

FIG. 3 is a flowchart of one embodiment of a process for new fault detection. The new fault detection process can be implemented by the new fault detector or similar component of the fault management system. A new fault can be defined as a system failure or similar event that triggers a system alarm or a trouble report to be generated by a monitoring system or other component. The fault is ‘new’ when it has not been detected or predicted by the fault inferencing system, which would indicate that the fault is known or ‘old.’ The new fault detector can be responsible for detecting new types or classes of faults. As used herein, ‘types’ and ‘classes’ or ‘classifications’ of faults are terms that are used interchangeably and do not indicate differences in these faults.

The new fault detector can compare a new alarm/trouble report from the TR mechanism to the inferencing results from the fault inferencing system. If the inferencing system has not successfully inferred a fault reported by the TR mechanism, then the new fault detector can generate a new fault request that is sent to the fault learning system. In the request, the type of data and the time window to collect data are described, along with the keywords that describe the fault. The provided keywords can be used by the fault inferencing system to report subsequent instances of the fault.

Referring to the example of FIG. 3, the new fault detector operation can be triggered in response to receipt of or notification of a new alarm or trouble report (e.g., from the TR mechanism), which the new fault detector accesses or reads (Block 301). The received alarm or trouble report is parsed or examined to determine a source of the alarm or trouble report (i.e., whether the source is the fault inferencing system) (Block 303). If the alarm or trouble report is received from the fault inferencing system, then no further action is taken, and a next report or alarm is awaited to trigger the activity of the new fault detector (Block 301).

If the received alarm or trouble report is not received from the fault inference system, then the new fault detector determines a timestamp for the alarm or trouble report and checks for any faults that were reported in a time range approximate to the timestamp (Block 305). If there is an inferred fault that correlates in time to the alarm or trouble report, then the new fault detector determines that the reported fault was inferred by the fault inference system and no further action is taken. The new fault detector awaits a next report or alarm to trigger further activity (Block 301).

If no fault is inferred by the fault inference system approximate to the timestamp of the fault from the alarm or trouble report, then the new fault detector determines that a new fault type/class has been encountered (Block 309). The new fault detector then determines the data to be collected that is relevant to the new fault. The relevant collected data can include data received from the monitoring system in a timeframe proximate to the newly detected fault. In addition, a key (e.g., a unique identifier) for the fault can be determined for the new fault to enable consistent identification of the fault. The collected fault information is sent by the new fault detector to the fault learning system with a request that will cause the fault learning system to classify and train a model for the fault (Block 311).

FIG. 4 is a diagram of one embodiment of a fault learning system. The fault learning system (i.e., Episodic Memory) (FLS) 203 trains a short-term neural network or similar machine-learning model that can identify a newly detected fault and determines whether the fault is ‘known’ to the system or has never been seen before and hence it is ‘unknown’ to the system. The FLS works closely with the fault classification system (FCS). FLS 203 can include a data sample repository 401, data similarity identifier 403, model trainer 405, model similarity identifier 407, decision maker 411, and parameter tuner 409.

The data sample repository 401 is a storage component that stores a limited set of data samples from all the faults that are known to the system. A ‘set,’ as used herein can be any whole number of items including one item. The set of data samples for each fault indicates the features that had the highest correlation with the occurrence of the specified faults. The data samples can be received from the new fault detector along with the identification of the new fault. In some embodiments, data samples can also be received or retrieved from the data collector.

The data similarity identifier 403 is a function that compares the newly arrived data samples corresponding to the newly detected fault with the samples from the known faults to find the similarity between them. In some embodiments, the process for comparison assumes that there is a total of K known faults in the fault management system, and Fₖ={f₁ₖ, . . . , fᵢₖ} is the set of features for fault k that consists of i features. Furthermore, assuming that Fₙ={f₁ₙ, . . . , fᵢₙ} is the feature set of the newly detected fault, the data similarity identifier component is to find the similarity between Fₙ and all Fₖϵ{1, . . . , K}. Using the data samples stored in the data sample repository 401, the data similarity identifier 403 compares two feature sets, and if a similarity of at least α percent is identified, the data similarity identifier 403 declares the two feature sets similar and declares the two feature sets dissimilar in all other cases (e.g., when the similarity is less than α percent). For instance, in the case where k is the network congestion fault and n is the network packet loss fault. These two faults have a number of network-related features in common, e.g., the amount of the received or sent bytes or packets. However, if n is the memory over-utilization fault, Fₙ mostly consists of features related to memory consumption, e.g., the allocated or inactive memory bytes, and thus, is likely dissimilar to Fₖ.

In the embodiments, the model trainer 405 is a function or component that trains a neural network fault detection model or similar machine learning model using the received new fault data. The new fault data is collected by the data collector based on the data descriptions in the new fault request from the new fault detector. The trained model will be further used to identify the possible similarities between the newly detected fault and known faults.

In some embodiments, a model similarity identifier 407 is a function or component that compares two fault detection models to find if they are similar. After identifying that fault k has similar data to the new fault data, the model similarity identifier 407 requests the retrieval of the fault detection model corresponding to fault k from the FCS. The model similarity identifier 407 compares the newly trained model using the new fault data, with the retrieved model, and identifies if the models are similar. To achieve this, the model similarity identifier 407 feed both models some data sample that have not been seen by the models before and calculates the distance between the detections of the models given a data sample. Moreover, the model similarity identifier 407 finds the average of the aforementioned distance over all the available data samples. Moreover, let Xₖ={x₁ₖ, . . . , xₛₖ} and Xₙ={x₁ₙ, . . . , xₛₙ} be the sets of data samples corresponding to the known fault k and the newly detected fault n, respectively. Hence, Mₖ(Xₖ) and Mₙ(Xₖ) are the detections made by the Mₖ and Mₙ models, respectively. Assuming that d (Mₖ(Xₖ), Mₙ(Xₖ)) is the distance between the detections of the two models, the similarity of the two models are calculated using

$$S = \frac{1}{\vert {X}_{k} ⋃ {X}_{n} \vert} {\sum }_{j = 1}^{\vert {X}_{k} ⋃ {X}_{n} \vert} d ( {M}_{n} ( {x}_{j} ) , {M}_{k} ( {x}_{j} ) ) .$$

Furthermore, if a similarity of at least β percent is achieved, the model similarity identifier 407 declares the two models to be similar and it declares them to be dissimilar in all other cases (e.g., when the similarity is less than β percent). In the case that there is no detection model corresponding to fault k in FCS, the model similarity identifier 407 component declares it to be a model dissimilar case.

The decision maker 411 is a function or component that operates based on the outputs of the data similarity identifier 403 and model similarity identifier 407. The decision maker 411 component decides what strategy to follow so that it learns the newly detected fault. One possible strategy is that if there is a similarity in both the data and the model, the decision maker 411 can decide to adjust the model of the known fault by continual learning to be able to further detect the new fault. Furthermore, this strategy could decide to train a new model for the newly detected fault if there is no similarity in the models, regardless of the similarity or dissimilarity in the data. The operation of the FLS is further described herein with relation to FIG. 5.

The parameter tuner 409 is a function or component that is responsible for setting the parameters for similarity α and β utilized by the data similarity identifier 403 and the model similarity identifier 407, and to further fine-tune them if necessary. Initially, the parameters α and β are set utilizing previous experience, i.e., how similar the features and the models detecting similar faults (e.g., network congestion and network packet loss) are. The FCS can also report a replay failure feedback to the parameter tuner 409, indicating the occurrence of a failure while applying the changes that were requested by the decision maker 411. The parameter tuner 409 can adjust the parameters α and β according to the received failure description.

An example of such a failure could be that the decision maker 411 decided to train a new model for the new detected fault, and the model tester component in the FCS detects that the new model can detect some known faults in addition to the new fault. This situation conveys that the values for the parameters α and β should be decreased to identify more features and models similar for future rounds of running the FLS. Similarly, the parameter tuner 409 can increase the values for the parameters α and β, if the failure description indicates that known faults are not detected using the model that was continually trained to detect the known faults and the new fault.

As the Parameter Tuner receives less failure feedbacks from the FLS, less adjustments would be needed to tune the parameters. Therefore, the parameter tuner 409 has two phases during the course of its run. First, in the growing phase it receives more failure feedbacks and tune the parameters more frequently. Once it finds the parameter values that result in rare failure feedbacks, it reaches its second phase referred to as the mature phase, where there are fewer failure feedbacks making the parameters more settled.

The components of the fault learning system are provided by way of example and not limitation. One skilled in the art would appreciate that the functions and components of the fault learning system can be differently combined, separated, or arranged consistent with the principles as described herein.

FIG. 5 is a flowchart of one embodiment of a process of a fault learning system. The process of the fault learning system can be triggered by receiving a call from the new fault detector and receiving a new set of data samples related to the new fault (Block 501). The new data samples can be provided as a parameter of the call from the new fault detector, retrieved from the data collector, or similarly obtained. A new machine learning model can be trained using the new set of data samples (Block 503). The newly trained model provides a starting point for identifying the new fault based on the context information that is available that describes the state of the system under monitor as reported by the monitoring system.

The new set of data samples can be compared with the previously collected data samples stored in the data sample repository of the FLS or in a similar storage location (Block 505). As described herein with relation to the data similarity identifier, the new data samples are compared against the previously collected data samples and a determination is made whether any of the previously collected data samples are sufficiently similar to meet a first similarity threshold value (Block 507). If the previously collected data samples are not sufficiently similar, then the process concludes that a new type of fault has been encountered and the newly trained model and the new data samples are stored in the episodic memory and data sample store, respectively. The new trained model is sent to the FCS along with the new data samples for further analysis and classification (Block 509).

If the new data samples are similar to at least one previous data sample set in the data sample repository where data sample sets are stored on a per model basis, then the data samples and the models of the similar faults are retrieved via a call to the FCS that identifies the fault (Block 511). The new model is compared with the model(s) of the similar fault(s) as described in relation to the model similarity identifier (Block 513). If the new model is similar to any of the retrieved model(s) within a second similarity threshold (Block 515), then the new data samples for the new fault are sent to the FCS to retrain or update the training of the existing similar model such that the fault inference system will be able to more accurately identify the already known fault (Block 517). If the new model is not similar to any existing model(s), the new fault model and related data samples can be stored in the episodic memory, and the data sample repository, respectively. Similarly, the FCS can be signaled to update the operation of the FCS to recognize the new type/class of fault.

FIG. 6 is diagram of one embodiment of a fault classification system. The fault classification system (FCS) 201 is responsible for classifying new faults and building a long-term semantic memory. FCS consists of five main components or functions: the semantic memory 601, the model trainer 609, the model tester 611, the data sample store 615, and the retrieve/replay handler 612. The semantic memory 601 stores trained fault detection and prediction models. In the semantic memory 601, there is a fault classifier 603 that can detect and classify the faults. The classifier is a neural network or similar machine learning model that classifies the input data samples as non-faults or a specific type of faults. Such a neural network can be designed in a way that e.g., in the output layer, each neural unit represents a type of faults. Faults that belong to the same type/class show some similarities in the input data, which is determined by the FLS as described in regard to FIGS. 4 and 5.

The fault classifier 603 can be initialized as a binary classifier that identifies faults and non faults. The initial training data set is stored in the data sample store 615. It can be a combination of data retrieved from the TR mechanism (e.g., fault data) and the monitoring system (non-fault data). The fault classifier 603 is updated when the FCS successfully learns a new fault. The episodic models used for learning the new faults are stored in an episodic model store, where the episodic model store 605 can have any format or storage organization. The models stored are searchable by a fault type and a fault key.

The semantic memory 601 also includes a fault prediction model list 607 that stores prediction models. Each prediction model is trained to predict a specific type/class of fault. The definition of type/class used by the prediction model is identical to the definition in the fault classifier 603. A prediction model is initially trained when there is a new type of fault, and the fault is predictable. It is updated when a new fault belonging to the same type is expected to be predicted using the same model.

The fault classification system further includes a model trainer 609. The model trainer 609 is responsible for training the neural networks or similar machine learning models for fault detection or fault prediction given the training data. It is also responsible for adjusting or partially training an existing model based on a specific action, e.g., adding a neural unit to the output layer and train the output layer. The actions are stored in training/adjustment policies of the FCS and determined by the retrieve/replay handler 613.

The model tester 611 is a function or component that tests a specific model given the test data and produces test results. The result can be the trained model that is selected based on critical metrics of accuracy, F-Scores, or similar prediction metrics.

The data sample store 615 component is a repository that consists of limited data samples from all the faults that are known to the system. Each record consists of a fault type, a fault key and the data sample(s) with selected features that had the highest correlation with the occurrence of the specified faults. The data sample store 615 also consists of non-fault data samples e.g., collected at different time stages (e.g., four days per month, spanning a year), or a long series (e.g., two months) of data from the system under monitoring. This data can be collected using any method or mechanism.

The retrieve and replay handler 613 is a function or component that handles retrieval and replay requests from FLS. Upon receiving a retrieval request (e.g., for fault type ‘k’), the retrieve and replay handler 613 gets the corresponding model (search fault type ‘k’) from the episodic model store and sends the model back to the FLS. Upon receiving a replay request, the retrieve/replay handler 615 first checks the “_type” parameter, to determine whether the replay request is for a new type of fault or a ‘known’ type of new fault. According to the type, the retrieve and replay handler then retrieves a respective policy from the training/adjustment policies configuration and adjusts/updates the models from semantic memory 601 according to the policies.

The policies are configurable by an operator and each policy consists of a type and a set of actions and can be denoted as: Policy {_type, [action]}. Some example policies can be found as follows, in which Policy 1 is used for adjusting the Fault Classifier 603 when there is a new type of fault, Policy 2 is used for adjusting Fault Classifier 603 when there is a new fault belonging to an existing type, and Policy 3 is used for adjusting a fault predictor so that it can predict a new fault as well as not forgetting the old faults. For example:
Policy 1: {“new_fault_type_classifier”, [add_new_output (model, new_output) and adjust_last_layer(model, data), adjust_first_layer(model, adjust_range, data), adjust_all_layers (model, adjust_range, data)]},
Policy 2: {“new_fault_classifier”, [add_branch_to_output (model, output_k, branch) and train_branch(model, branch, data), adjust_last_layer(model, data), adjust_first_layer(model, adjust_range, data), adjust_all_layers (model, adjust_range, data)]}, and
Policy 3: {“adjust_predictor”, [add_branch_to_output (model) and train_branch(model, branch, data), adjust_first_layer(model, adjust_range, data), adjust_all_layers (model, adjust_range, data)]}

In this example, the first action for a new type of fault is to add a new output unit, and several intermediate units connecting the input and output. The structure of the intermediate units and parameters can be taken from the model trained by the episodic memory. Once the new output is added, the policy adjusts the output layer of the fault classifier 603 using samples of all fault and non-fault data from the data sample store 615. The second and third actions are only taken when process cannot achieve the expected results from the previous action(s). These actions adjust the first layer parameters of the fault classifier 603 and adjust all parameters of the fault classifier, respectively. Note that the parameter adjustment shall be in a pre-defined range in order to avoid retraining the whole model.

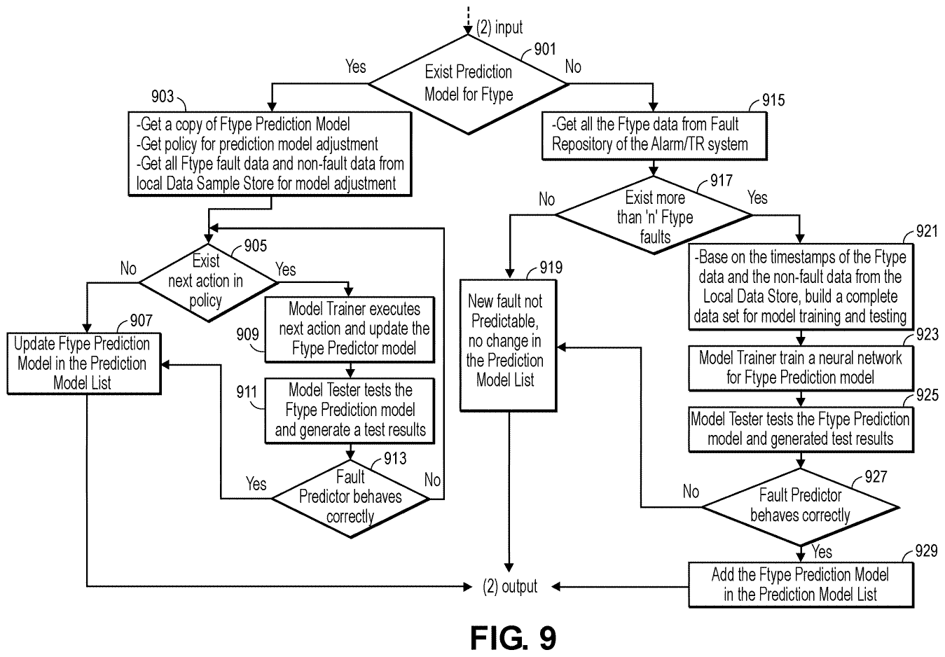

If the retrained fault classifier 603 cannot converge (i.e., correctly detect the new fault, old faults, and non-fault) after all the actions in the policy are executed, a replay failed response can be sent back to FLS for further parameter adjustment. In such a case, the retrained fault classifier 603 is discarded. After a new fault is successfully learned by the fault classifier 603, the retrieve and replay handler 613 checks whether the new fault is predictable or not and if predictable, the retrieve and replay handler 613 then trains a new fault prediction model or adjusts an existing model based on the type of the new fault. An example of how to determine if a fault is predictable, and the process of updating the prediction model list 607 is described in regard to FIG. 9.

Once there is a model update in the semantic memory 601, the retrieve and replay handler 613 can send a model update request to the fault inferencing system, which will use the up-to-date models for online inferencing.

The components of the fault classification system 201 are provided by way of example and not limitation. One skilled in the art would appreciate that the functions and components of the fault classification system 201 can be differently combined, separated, or arranged consistent with the principles as described herein.

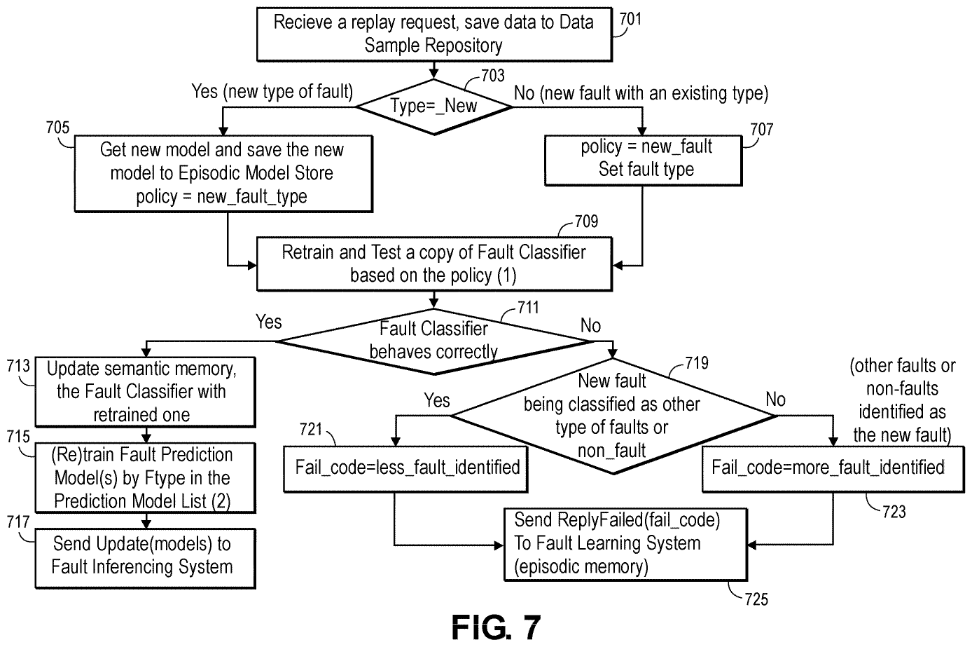

FIG. 7 is a flowchart of one embodiment of the replay process of the fault classification system. The replay process of the FCS can be triggered in response to receiving a replay request from an FLS. The replay request can be received causing a save of related sample data to the data sample repository (Block 701). A check is made of the data received with the replay request to determine if a new fault type has been identified (Block 703). If the received replay request is for a new type of fault, then the FCS can retrieve a new model that has been created and save the new model to the episodic model store policies (Block 705). If the received request data indicates that the fault is not a new type of fault, then the FCS can set the policy to create a new_fault and fault type combination (Block 707). After the policies are set by the FCS, then the fault classifier can be retrained and tested based on the new policies (Block 709).

After the fault classifier is retrained based on the basic policy, a check is made to determine whether the fault classifier operates/behaves properly (Block 711). If the fault classifier does behave correctly (i.e., accurately identifies the types of faults), then the semantic memory can be updated, and the fault classifier updated/replaced by the retrained fault classifier (Block 713). Fault prediction models by fault type (Ftype) in the prediction model list are updated/retrained (Block 715) and the updated models are then sent to the fault inferencing system (Block 717).

Where the fault classifier does not behave properly (Block 711), a check is made whether the new fault being classified is being classified as another type of fault or a non-fault (Block 719). If the new fault is being classified as another type of fault, then the fail code is set to less_fault_identified (Block 721) and the reply of replay failed identified along with the fail code are sent to the fault learning system (Block 7125). However, if the new fault is classified as another type or non_fault, then the fail code is set to more_fault_identified and the reply of replay failed is sent along with fail code to the fault learning system (Block 725).

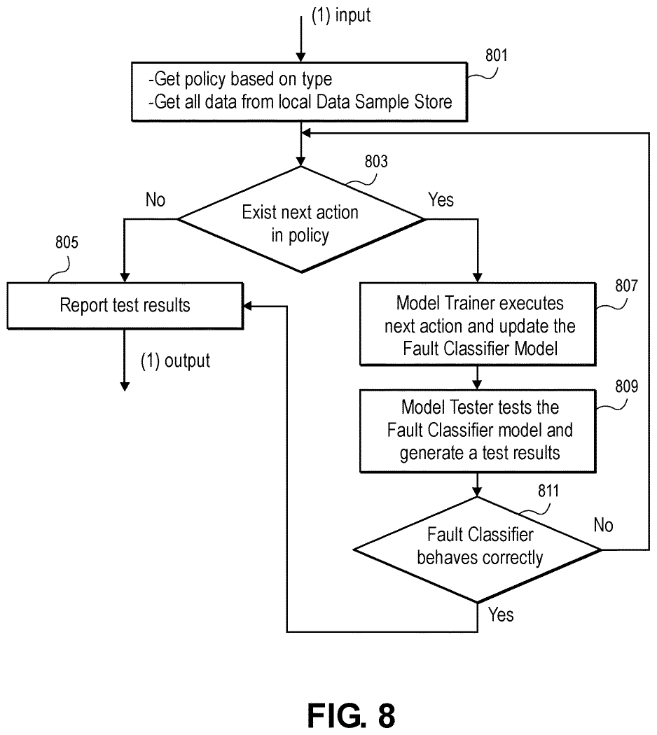

FIG. 8 is an example of a flowchart for retraining and testing a fault classifier based on policy. This process is triggered during the replay process as illustrated in FIG. 7 (Block 709). The FCS retrieves policies based on the fault type and retrieves all data from the local data sample store for the fault type (Block 801). A check is then made whether there are additional actions to process in the retrieved policies (Block 803). If there are no further actions to process in the retrieved policies, then the process reports the test results (Block 805) and returns to the process of FIG. 7 (Block 709).

If there are additional actions to process in the retrieved policies, then the model trainer executes the next action and updates the fault classifier model accordingly (Block 807). The model tester then tests the updated fault classifier model and generates a test result that measures the accuracy of the updated fault classifier model (Block 809). If the updated fault classifier behaves properly (i.e., accurately identifies fault types), then the test results are returned (Block 805) and the process returns to FIG. 7 (Block 709). However, if the fault classifier continues to behave inaccurately, then the next action in the retrieved policies is retrieved to be executed (Block 803).

FIG. 9 is a flowchart of one embodiment of a process for a fault prediction model update. This process is triggered by a call to retrain the fault prediction models of FIG. 7 (Block 715). When this process is triggered, a check is made to determine whether a prediction model exists in the semantic memory for the fault type (Block 901). If the prediction model exists, then a copy of the fault type prediction model is retrieved, policies for prediction model adjustment are retrieved, and all relevant fault type fault data and non-fault data from the data sample store for model adjustment are retrieved (Block 903). A check is then made whether all of the actions in the retrieved policies have been processed (Block 905).

If all of the actions have not been processed, then the model trainer executes the next action and updates the fault type prediction model (Block 909). The model tester tests the fault type prediction model and generates a test result (Block 911). A check is then made whether the fault predictor behaves correctly (Block 913). If the fault predictor behaves correctly, then the fault type prediction model in the prediction model list can be updated (Block 907). If the fault predictor does not behave properly (i.e., is inaccurate), then the process proceeds to check for the next action in the retrieved policies to apply in an attempt to correct the inaccuracy (Block 905). This process can continue until all of the actions and policies are exhausted or the fault predictor is accurate.

In the case where no prediction model existed for the fault type (Block 901), then the FCS can retrieve the fault type data from the fault repository of the TR mechanism (Block 915). A check is then made to determine whether there are multiple applicable fault types (Block 917). If there are not multiple ‘n’ fault types, then the new fault is determined to be unpredictable and there is no change to the prediction model list (Block 919). If there are multiple ‘n’ fault types that are applicable, then the process builds a complete data set for model training and testing based on the timestamps of the fault type data and the non-fault data from the local data store (Block 921). The model trainer trains the neural network or similar machine learning model for the fault type prediction model (Block 922). The model tester tests the fault type prediction model and generates a test result (Block 925). If the fault protector however does not behave properly/accurately, then the fault is identified as unpredictable (Block 919), and no change is made to the prediction model list.

If the fault predictor does not behave properly (Block 927), then the fault type prediction model in the prediction model list is not changed and the fault labeled unpredictable (Block 919). If the fault predictor does behave correctly, the fault type prediction model is added to the prediction model list (Block 929). After the update of the prediction model list in each case, the FCS process exits and returns to the calling process of FIG. 7.

FIG. 10 is a diagram of one embodiment of a fault inference system. The fault inference system includes an inferencing handler 1005, a set of models downloaded from the FCS 1007, and a fault classifier 1003. The fault inference system 1000 components and functions of the inferencing process are depicted in FIG. 10, while the process of these components is illustrated in FIG. 11. The fault classifier 1003 processes received fault data to identify a fault type. Where a fault type is identified, then the inference handler retrieves and applies the fault predictions models as described herein. The output of the fault inferencing system is a predicted fault type, key, timestamp, and similar data.

FIG. 11 is a flowchart of one embodiment of a process of the fault inferencing system. The process can be triggered in response to periodic input or newly detected input. The process can use fault classifiers and fault prediction models from the FCS (Block 1101). The process applies a fault classifier and each of the fault prediction models to the input data and determines online inferencing results for these fault classifier and fault prediction models as applied to the input data. A check is made whether a fault is detected by the fault classifier (Block 1105). If a fault is detected by the fault classifier, then a fault indicator is sent to the Alarm/TR mechanism using the FaultDetected( ) function (Block 1113).

In some embodiments, in the case where a fault is not detected by a fault classifier, then a check as to whether the fault prediction models can predict at least one fault can be checked (Block 1107). If no fault is predicted, the process waits for the further faults or related input to be created or received (Block 1101).

Where a fault is predicted (Block 1107), then based on the fault type, the inferencing result from the corresponding models are used to build the fault detected/predicted alerts (Block 1109). Then the fault (e.g., using the FaultPredicted( ) function) can be sent to the TR mechanism (Block 1111).

Knowledge transfer between instances of the processes described herein as well as a similar function for transfer between instances at different locations can be adapted for an edge cloud environment. The embodiments facilitate the knowledge sharing among a particular type of edge sites (e.g., an open Radio Access Network site, an off-loading site involving several servers and accelerators, or an Internet of Things (IoT) site for robots).

When initially deploying the fault management system to an operating environment like a first edge site of a specific type, the long-term semantic memory can be ‘slowly’ built, and once the semantic memory reaches the mature phase, it can be transferred to other edge sites with similar hardware and software settings for reuse. As each edge site has its own fault learning and inferencing system, the transferred semantic memory speeds up the fault learning process while it evolves over time to adapt to the faults occurred in the specific edge site.

It is also possible for an edge site to share a newly learned fault among its type of edge sites. This can be done, e.g., via sharing the new fault data among sites. However, in such cases, there can be security agreement among sites to protect this information. The actual knowledge transfer method can be any compatible method or process. The functional components defined in the described embodiments are logical entities. They can be realized and deployed in distributed cloud environments, e.g., as docker containers.

Thus, the embodiments of the fault management system as described herein provide a system that learns a fault when it occurs, classifies the fault and trains models for fault detection and prediction, which the system then implements. The fault learning system receives a new fault request from the new fault detector, collecting the new fault data using the data collector. The fault learning system trains a short-term neural network or similar machine learning model that can identify/detect the new fault. The process compares the data similarity between the new fault and the existing faults retrieved from the fault classification system and if any similarity exists, the process further compares the output similarity between the new model and the existing model and thus decides if the new fault can be classified as a new type of fault or an existing one. Otherwise, the process sets the new fault as new type of fault. Handling the new fault includes using requests or calls to the fault classification system to replay and classify the new fault. The FLS can adjust data and model similarity parameters if it receives replay failed message from the FCS. The FCS receives replay requests from the FLS. The process identifies if the new fault is a new type of fault, or a new fault belonging to an existing type. In the former case, follows the new type retraining policy by adding a new output to the fault classifier neural network and adjust model parameters accordingly. For the latter case, follows the existing type retraining policy by adding a new branch to an existing output of the fault classifier neural network and adjust model parameters accordingly. The retrained fault classifier finds out if the classifier can correctly classify both the new fault and existing faults. The fault classifier sends replay failed requests to the FLS if the fault classifier does not behave correctly.

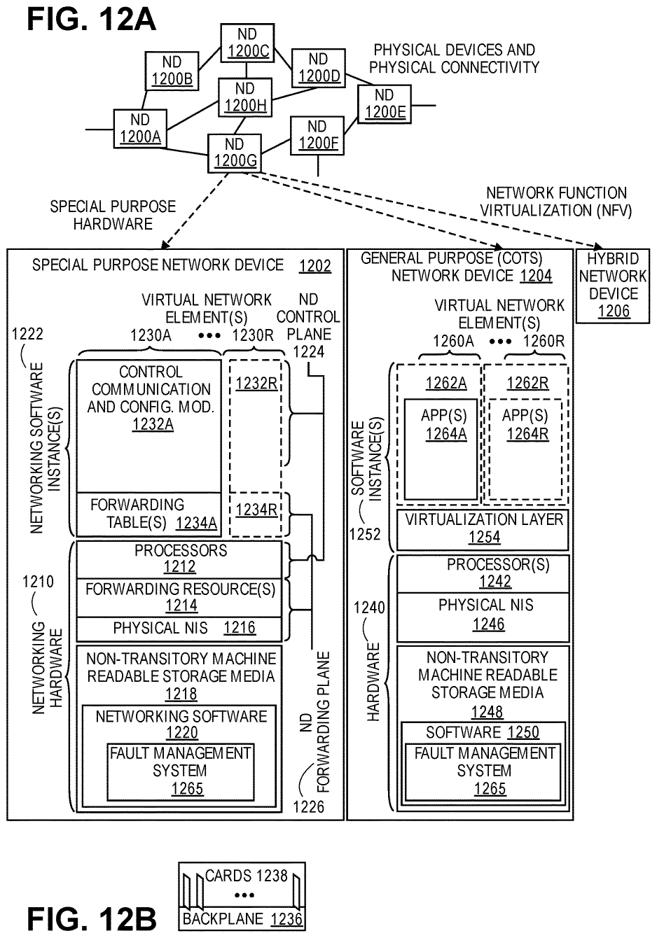

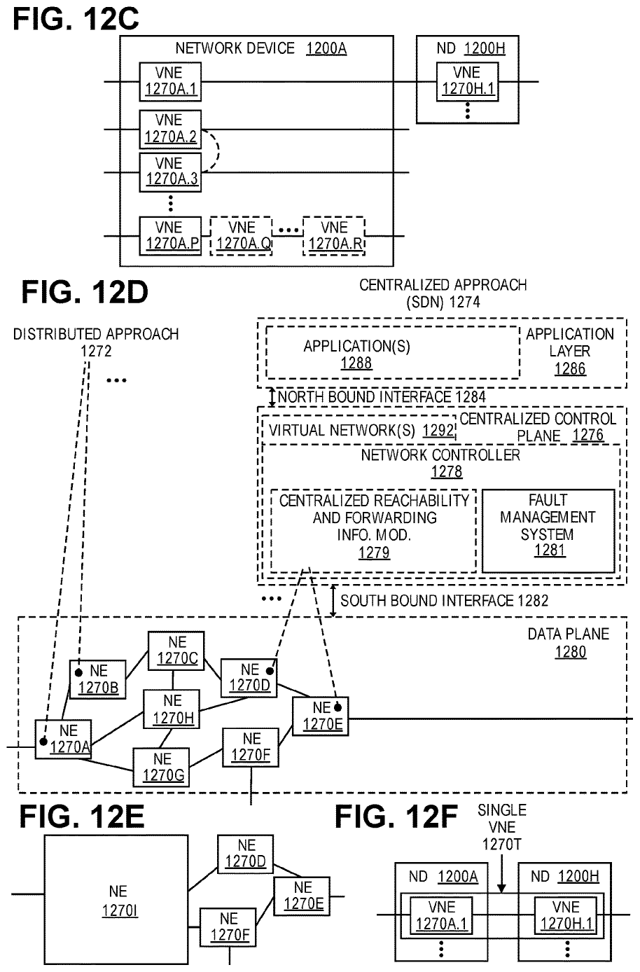

FIG. 12A illustrates connectivity between network devices (NDs) within an exemplary network, as well as three exemplary implementations of the NDs, according to some embodiments. FIG. 12A shows NDs 1200A-H, and their connectivity by way of lines between 1200A-1200B, 1200B-1200C, 1200C-1200D, 1200D-1200E, 1200E-1200F, 1200F-1200G, and 1200A-1200G, as well as between 1200H and each of 1200A, 1200C, 1200D, and 1200G. These NDs are physical devices, and the connectivity between these NDs can be wireless or wired (often referred to as a link). An additional line extending from NDs 1200A, 1200E, and 1200F illustrates that these NDs act as ingress and egress points for the network (and thus, these NDs are sometimes referred to as edge NDs; while the other NDs may be called core NDs).

Two of the exemplary ND implementations in FIG. 12A are: 1) a special-purpose network device 1202 that uses custom application-specific integrated-circuits (ASICs) and a special-purpose operating system (OS); and 2) a general purpose network device 1204 that uses common off-the-shelf (COTS) processors and a standard OS.

The special-purpose network device 1202 includes networking hardware 1210 comprising a set of one or more processor(s) 1212, forwarding resource(s) 1214 (which typically include one or more ASICs and/or network processors), and physical network interfaces (NIs) 1216 (through which network connections are made, such as those shown by the connectivity between NDs 1200A-H), as well as non-transitory machine readable storage media 1218 having stored therein networking software 1220. During operation, the networking software 1220 may be executed by the networking hardware 1210 to instantiate a set of one or more networking software instance(s) 1222. Each of the networking software instance(s) 1222, and that part of the networking hardware 1210 that executes that network software instance (be it hardware dedicated to that networking software instance and/or time slices of hardware temporally shared by that networking software instance with others of the networking software instance(s) 1222), form a separate virtual network element 1230A-R. Each of the virtual network element(s) (VNEs) 1230A-R includes a control communication and configuration module 1232A-R (sometimes referred to as a local control module or control communication module) and forwarding table(s) 1234A-R, such that a given virtual network element (e.g., 1230A) includes the control communication and configuration module (e.g., 1232A), a set of one or more forwarding table(s) (e.g., 1234A), and that portion of the networking hardware 1210 that executes the virtual network element (e.g., 1230A).

The special-purpose network device 1202 is often physically and/or logically considered to include: 1) a ND control plane 1224 (sometimes referred to as a control plane) comprising the processor(s) 1212 that execute the control communication and configuration module(s) 1232A-R; and 2) a ND forwarding plane 1226 (sometimes referred to as a forwarding plane, a data plane, or a media plane) comprising the forwarding resource(s) 1214 that utilize the forwarding table(s) 1234A-R and the physical NIs 1216. By way of example, where the ND is a router (or is implementing routing functionality), the ND control plane 1224 (the processor(s) 1212 executing the control communication and configuration module(s) 1232A-R) is typically responsible for participating in controlling how data (e.g., packets) is to be routed (e.g., the next hop for the data and the outgoing physical NI for that data) and storing that routing information in the forwarding table(s) 1234A-R, and the ND forwarding plane 1226 is responsible for receiving that data on the physical NIs 1216 and forwarding that data out the appropriate ones of the physical NIs 1216 based on the forwarding table(s) 1234A-R.

FIG. 12B illustrates an exemplary way to implement the special-purpose network device 1202 according to some embodiments. FIG. 12B shows a special-purpose network device including cards 1238 (typically hot pluggable). While in some embodiments the cards 1238 are of two types (one or more that operate as the ND forwarding plane 1226 (sometimes called line cards), and one or more that operate to implement the ND control plane 1224 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1236 (e.g., a first full mesh coupling the line cards and a second full mesh coupling all of the cards).

In some embodiments, the fault management system 1265 as described herein or any component or function thereof can be stored in the non-transitory machine-readable storage media 1218 (e.g., as part of the networking software 1220). The fault management system 1265 can be executed by the processors 1212.

Returning to FIG. 12A, the general purpose network device 1204 includes hardware 1240 comprising a set of one or more processor(s) 1242 (which are often COTS processors) and physical NIs 1246, as well as non-transitory machine readable storage media 1248 having stored therein software 1250. During operation, the processor(s) 1242 execute the software 1250 to instantiate one or more sets of one or more applications 1264A-R. While one embodiment does not implement virtualization, alternative embodiments may use different forms of virtualization. For example, in one such alternative embodiment the virtualization layer 1254 represents the kernel of an operating system (or a shim executing on a base operating system) that allows for the creation of multiple instances 1262A-R called software containers that may each be used to execute one (or more) of the sets of applications 1264A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1254 represents a hypervisor (sometimes referred to as a virtual machine monitor (VMM)) or a hypervisor executing on top of a host operating system, and each of the sets of applications 1264A-R is run on top of a guest operating system within an instance 1262A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1240, directly on a hypervisor (in which case the unikernel is sometimes described as running within a LibOS virtual machine), or in a software container, embodiments can be implemented fully with unikernels running directly on a hypervisor represented by virtualization layer 1254, unikernels running within software containers represented by instances 1262A-R, or as a combination of unikernels and the above-described techniques (e.g., unikernels and virtual machines both run directly on a hypervisor, unikernels and sets of applications that are run in different software containers).

In some embodiments, the fault management system 1265 as described herein or any component or function thereof can be stored in the non-transitory machine-readable storage media 1248 (e.g., as part of the software 1250). The fault management system 1265 can be executed by the processors 1242.

The instantiation of the one or more sets of one or more applications 1264A-R, as well as virtualization if implemented, are collectively referred to as software instance(s) 1252. Each set of applications 1264A-R, corresponding virtualization construct (e.g., instance 1262A-R) if implemented, and that part of the hardware 1240 that executes them (be it hardware dedicated to that execution and/or time slices of hardware temporally shared), forms a separate virtual network element(s) 1260A-R.

The virtual network element(s) 1260A-R perform similar functionality to the virtual network element(s) 1230A-R—e.g., similar to the control communication and configuration module(s) 1232A and forwarding table(s) 1234A (this virtualization of the hardware 1240 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 1262A-R corresponding to one VNE 1260A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1262A-R to VNEs also apply to embodiments where such a finer level of granularity and/or unikernels are used.

In certain embodiments, the virtualization layer 1254 includes a virtual switch that provides similar forwarding services as a physical Ethernet switch. Specifically, this virtual switch forwards traffic between instances 1262A-R and the physical NI(s) 1246, as well as optionally between the instances 1262A-R; in addition, this virtual switch may enforce network isolation between the VNEs 1260A-R that by policy are not permitted to communicate with each other (e.g., by honoring virtual local area networks (VLANs)).

The third exemplary ND implementation in FIG. 12A is a hybrid network device 1206, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1202) could provide for para-virtualization to the networking hardware present in the hybrid network device 1206.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1230A-R, VNEs 1260A-R, and those in the hybrid network device 1206) receives data on the physical NIs (e.g., 1216, 1246) and forwards that data out the appropriate ones of the physical NIs (e.g., 1216, 1246). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 12C illustrates various exemplary ways in which VNEs may be coupled according to some embodiments. FIG. 12C shows VNEs 1270A.1-1270A.P (and optionally VNEs 1270A.Q-1270A.R) implemented in ND 1200A and VNE 1270H.1 in ND 1200H. In FIG. 12C, VNEs 1270A.1-P are separate from each other in the sense that they can receive packets from outside ND 1200A and forward packets outside of ND 1200A; VNE 1270A.1 is coupled with VNE 1270H.1, and thus they communicate packets between their respective NDs; VNE 1270A.2-1270A.3 may optionally forward packets between themselves without forwarding them outside of the ND 1200A; and VNE 1270A.P may optionally be the first in a chain of VNEs that includes VNE 1270A.Q followed by VNE 1270A.R (this is sometimes referred to as dynamic service chaining, where each of the VNEs in the series of VNEs provides a different service—e.g., one or more layer 4-7 network services). While FIG. 12C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 12A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 12A may also host one or more such servers (e.g., in the case of the general purpose network device 1204, one or more of the software instances 1262A-R may operate as servers; the same would be true for the hybrid network device 1206; in the case of the special-purpose network device 1202, one or more such servers could also be run on a virtualization layer executed by the processor(s) 1212); in which case the servers are said to be co-located with the VNEs of that ND.

A virtual network is a logical abstraction of a physical network (such as that in FIG. 12A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 12D illustrates a network with a single network element on each of the NDs of FIG. 12A, and within this straightforward approach contrasts a traditional distributed approach (commonly used by traditional routers) with a centralized approach for maintaining reachability and forwarding information (also called network control), according to some embodiments. Specifically, FIG. 12D illustrates network elements (NEs) 1270A-H with the same connectivity as the NDs 1200A-H of FIG. 12A.

FIG. 12D illustrates that the distributed approach 1272 distributes responsibility for generating the reachability and forwarding information across the NEs 1270A-H; in other words, the process of neighbor discovery and topology discovery is distributed.

For example, where the special-purpose network device 1202 is used, the control communication and configuration module(s) 1232A-R of the ND control plane 1224 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 1270A-H (e.g., the processor(s) 1212 executing the control communication and configuration module(s) 1232A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 1224. The ND control plane 1224 programs the ND forwarding plane 1226 with information (e.g., adjacency and route information) based on the routing structure(s). For example, the ND control plane 1224 programs the adjacency and route information into one or more forwarding table(s) 1234A-R (e.g., Forwarding Information Base (FIB), Label Forwarding Information Base (LFIB), and one or more adjacency structures) on the ND forwarding plane 1226. For layer 2 forwarding, the ND can store one or more bridging tables that are used to forward data based on the layer 2 information in that data. While the above example uses the special-purpose network device 1202, the same distributed approach 1272 can be implemented on the general purpose network device 1204 and the hybrid network device 1206.

FIG. 12D illustrates that a centralized approach 1274 (also known as software defined networking (SDN)) that decouples the system that makes decisions about where traffic is sent from the underlying systems that forwards traffic to the selected destination. The illustrated centralized approach 1274 has the responsibility for the generation of reachability and forwarding information in a centralized control plane 1276 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 1276 has a south bound interface 1282 with a data plane 1280 (sometime referred to the infrastructure layer, network forwarding plane, or forwarding plane (which should not be confused with a ND forwarding plane)) that includes the NEs 1270A-H (sometimes referred to as switches, forwarding elements, data plane elements, or nodes). The centralized control plane 1276 includes a network controller 1278, which includes a centralized reachability and forwarding information module 1279 that determines the reachability within the network and distributes the forwarding information to the NEs 1270A-H of the data plane 1280 over the south bound interface 1282 (which may use the OpenFlow protocol). Thus, the network intelligence is centralized in the centralized control plane 1276 executing on electronic devices that are typically separate from the NDs.

For example, where the special-purpose network device 1202 is used in the data plane 1280, each of the control communication and configuration module(s) 1232A-R of the ND control plane 1224 typically include a control agent that provides the VNE side of the south bound interface 1282. In this case, the ND control plane 1224 (the processor(s) 1212 executing the control communication and configuration module(s) 1232A-R) performs its responsibility for participating in controlling how data (e.g., packets) is to be routed (e.g., the next hop for the data and the outgoing physical NI for that data) through the control agent communicating with the centralized control plane 1276 to receive the forwarding information (and in some cases, the reachability information) from the centralized reachability and forwarding information module 1279 (it should be understood that in some embodiments, the control communication and configuration module(s) 1232A-R, in addition to communicating with the centralized control plane 1276, may also play some role in determining reachability and/or calculating forwarding information-albeit less so than in the case of a distributed approach; such embodiments are generally considered to fall under the centralized approach 1274, but may also be considered a hybrid approach).

While the above example uses the special-purpose network device 1202, the same centralized approach 1274 can be implemented with the general purpose network device 1204 (e.g., each of the VNE 1260A-R performs its responsibility for controlling how data (e.g., packets) is to be routed (e.g., the next hop for the data and the outgoing physical NI for that data) by communicating with the centralized control plane 1276 to receive the forwarding information (and in some cases, the reachability information) from the centralized reachability and forwarding information module 1279; it should be understood that in some embodiments, the VNEs 1260A-R, in addition to communicating with the centralized control plane 1276, may also play some role in determining reachability and/or calculating forwarding information-albeit less so than in the case of a distributed approach) and the hybrid network device 1206. In fact, the use of SDN techniques can enhance the NFV techniques typically used in the general purpose network device 1204 or hybrid network device 1206 implementations as NFV is able to support SDN by providing an infrastructure upon which the SDN software can be run, and NFV and SDN both aim to make use of commodity server hardware and physical switches.

FIG. 12D also shows that the centralized control plane 1276 has a north bound interface 1284 to an application layer 1286, in which resides application(s) 1288. The centralized control plane 1276 has the ability to form virtual networks 1292 (sometimes referred to as a logical forwarding plane, network services, or overlay networks (with the NEs 1270A-H of the data plane 1280 being the underlay network)) for the application(s) 1288. Thus, the centralized control plane 1276 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

In some embodiments, the fault management system 1281 as described herein or any component or function thereof can be stored and/or executed at the centralized control plane 1276.

While FIG. 12D shows the distributed approach 1272 separate from the centralized approach 1274, the effort of network control may be distributed differently or the two combined in certain embodiments. For example: 1) embodiments may generally use the centralized approach (SDN) 1274, but have certain functions delegated to the NEs (e.g., the distributed approach may be used to implement one or more of fault monitoring, performance monitoring, protection switching, and primitives for neighbor and/or topology discovery); or 2) embodiments may perform neighbor discovery and topology discovery via both the centralized control plane and the distributed protocols, and the results compared to raise exceptions where they do not agree. Such embodiments are generally considered to fall under the centralized approach 1274, but may also be considered a hybrid approach.

While FIG. 12D illustrates the simple case where each of the NDs 1200A-H implements a single NE 1270A-H, it should be understood that the network control approaches described with reference to FIG. 12D also work for networks where one or more of the NDs 1200A-H implement multiple VNEs (e.g., VNEs 1230A-R, VNEs 1260A-R, those in the hybrid network device 1206). Alternatively or in addition, the network controller 1278 may also emulate the implementation of multiple VNEs in a single ND. Specifically, instead of (or in addition to) implementing multiple VNEs in a single ND, the network controller 1278 may present the implementation of a VNE/NE in a single ND as multiple VNEs in the virtual networks 1292 (all in the same one of the virtual network(s) 1292, each in different ones of the virtual network(s) 1292, or some combination). For example, the network controller 1278 may cause an ND to implement a single VNE (a NE) in the underlay network, and then logically divide up the resources of that NE within the centralized control plane 1276 to present different VNEs in the virtual network(s) 1292 (where these different VNEs in the overlay networks are sharing the resources of the single VNE/NE implementation on the ND in the underlay network).

On the other hand, FIGS. 12E and 12F respectively illustrate exemplary abstractions of NEs and VNEs that the network controller 1278 may present as part of different ones of the virtual networks 1292. FIG. 12E illustrates the simple case of where each of the NDs 1200A-H implements a single NE 1270A-H (see FIG. 12D), but the centralized control plane 1276 has abstracted multiple of the NEs in different NDs (the NEs 1270A-C and G-H) into (to represent) a single NE 1270I in one of the virtual network(s) 1292 of FIG. 12D, according to some embodiments. FIG. 12E shows that in this virtual network, the NE 1270I is coupled to NE 1270D and 1270F, which are both still coupled to NE 1270E.

FIG. 12F illustrates a case where multiple VNEs (VNE 1270A.1 and VNE 1270H.1) are implemented on different NDs (ND 1200A and ND 1200H) and are coupled to each other, and where the centralized control plane 1276 has abstracted these multiple VNEs such that they appear as a single VNE 1270T within one of the virtual networks 1292 of FIG. 12D, according to some embodiments. Thus, the abstraction of a NE or VNE can span multiple NDs.

While some embodiments implement the centralized control plane 1276 as a single entity (e.g., a single instance of software running on a single electronic device), alternative embodiments may spread the functionality across multiple entities for redundancy and/or scalability purposes (e.g., multiple instances of software running on different electronic devices).

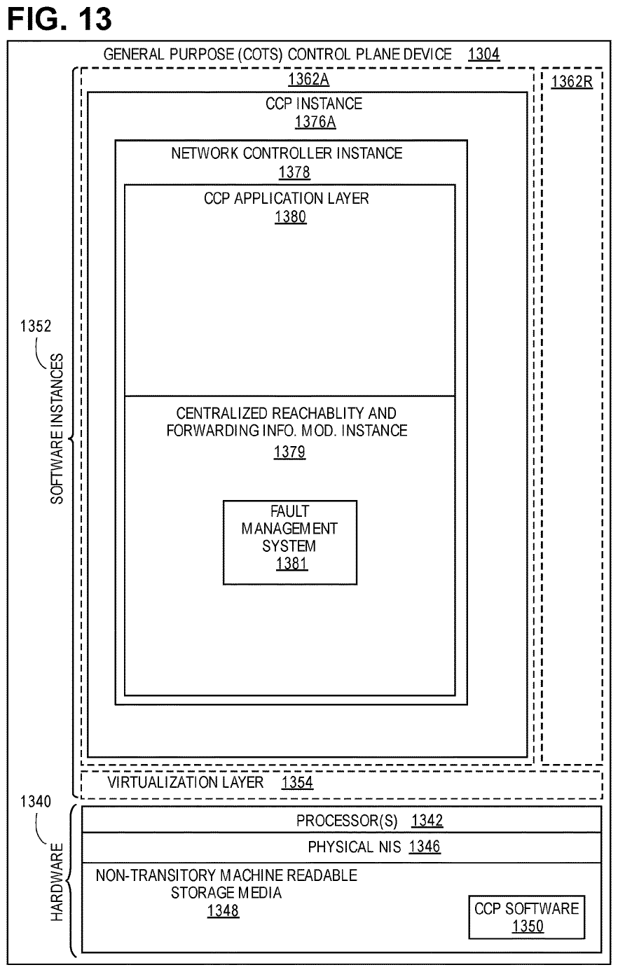

Similar to the network device implementations, the electronic device(s) running the centralized control plane 1276, and thus the network controller 1278 including the centralized reachability and forwarding information module 1279, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 13 illustrates, a general purpose control plane device 1304 including hardware 1340 comprising a set of one or more processor(s) 1342 (which are often COTS processors) and physical NIs 1346, as well as non-transitory machine readable storage media 1348 having stored therein centralized control plane (CCP) software 1350.

In some embodiments, the fault management system 1381 as described herein or any component or function thereof can be stored in the non-transitory machine-readable storage media 1348. The fault management system 1381 can be executed by the processors 1342.

In embodiments that use compute virtualization, the processor(s) 1342 typically execute software to instantiate a virtualization layer 1354 (e.g., in one embodiment the virtualization layer 1354 represents the kernel of an operating system (or a shim executing on a base operating system) that allows for the creation of multiple instances 1362A-R called software containers (representing separate user spaces and also called virtualization engines, virtual private servers, or jails) that may each be used to execute a set of one or more applications; in another embodiment the virtualization layer 1354 represents a hypervisor (sometimes referred to as a virtual machine monitor (VMM)) or a hypervisor executing on top of a host operating system, and an application is run on top of a guest operating system within an instance 1362A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1340, directly on a hypervisor represented by virtualization layer 1354 (in which case the unikernel is sometimes described as running within a LibOS virtual machine), or in a software container represented by one of instances 1362A-R). Again, in embodiments where compute virtualization is used, during operation an instance of the CCP software 1350 (illustrated as CCP instance 1376A) is executed (e.g., within the instance 1362A) on the virtualization layer 1354. In embodiments where compute virtualization is not used, the CCP instance 1376A is executed, as a unikernel or on top of a host operating system, on the “bare metal” general purpose control plane device 1304. The instantiation of the CCP instance 1376A, as well as the virtualization layer 1354 and instances 1362A-R if implemented, are collectively referred to as software instance(s) 1352.

In some embodiments, the CCP instance 1376A includes a network controller instance 1378. The network controller instance 1378 includes a centralized reachability and forwarding information module instance 1379 (which is a middleware layer providing the context of the network controller 1278 to the operating system and communicating with the various NEs), and an CCP application layer 1380 (sometimes referred to as an application layer) over the middleware layer (providing the intelligence required for various network operations such as protocols, network situational awareness, and user-interfaces). At a more abstract level, this CCP application layer 1380 within the centralized control plane 1276 works with virtual network view(s) (logical view(s) of the network) and the middleware layer provides the conversion from the virtual networks to the physical view.

The centralized control plane 1276 transmits relevant messages to the data plane 1280 based on CCP application layer 1380 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 1280 may receive different messages, and thus different forwarding information. The data plane 1280 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 1280, the packet (or a subset of the packet header and content) is typically forwarded to the centralized control plane 1276. The centralized control plane 1276 will then program forwarding table entries into the data plane 1280 to accommodate packets belonging to the flow of the unknown packet. Once a specific forwarding table entry has been programmed into the data plane 1280 by the centralized control plane 1276, the next packet with matching credentials will match that forwarding table entry and take the set of actions associated with that matched entry.

For example, while the flow diagrams in the figures show a particular order of operations performed by certain embodiments, it should be understood that such order is exemplary (e.g., alternative embodiments may perform the operations in a different order, combine certain operations, overlap certain operations, etc.).

While the operations and structures been described in terms of several embodiments, those skilled in the art will recognize that the embodiments is not limited to the embodiments described, can be practiced with modification and alteration within the spirit and scope of the appended claims. The description is thus to be regarded as illustrative instead of limiting.

1. A method for identifying and handling new fault types, the method comprising:
receiving a new set of data samples related to a new fault;
training a new model for the new fault using the new set of data samples;
comparing the new set of data samples against a set of previously collected data samples; and
storing the new model in an episodic model store, in response to a similarity of the new set of data samples and the set of previously collected data samples failing to meet a first threshold level of similarity.

2. The method of claim 1, further comprising:
retrieving a set of prior models from the episodic model store; and
comparing a similarity of the set of prior models with the new model.

3. The method of claim 2, further comprising:
storing the new model in the episodic model store, in response to the similarity of the new model and the set of prior models failing to meet a second threshold level of similarity.

4. The method of claim 1, further comprising:
storing the new set of data samples in a data sample store, in response to the similarity of the new set of data samples being within the first threshold level of similarity with the set of previously collected data samples.

5. The method of claim 3, further comprising:
retraining a fault classifier in response to the similarity of the new model and at least one model in the set of prior models meeting the second threshold level of similarity.

6. The method of claim 5, further comprising:
updating the fault classifier and semantic memory with a retrained fault classifier in response to testing correct fault classifier behavior for the new fault.

7. The method of claim 1, further comprising:
updating a fault type prediction model in a prediction model list to be a retrained fault type prediction model, in response to successful retraining of an existing fault type prediction model; and
updating the fault type prediction model in the prediction model list to be a new fault type prediction model, in response to successful training of the new fault type prediction model where the existing fault type prediction model is not found.

8. A non-transitory machine-readable storage medium comprising computer program code, which computer program code when executed by a processor, perform operations for identifying and handling new fault types comprising:
receiving a new set of data samples related to a new fault;
training a new model for the new fault using the new set of data samples;
comparing the new set of data samples against a set of previously collected data samples; and
storing the new model in an episodic model store, in response to a similarity of the new set of data samples and the set of previously collected data samples failing to meet a first threshold level of similarity.

9. An electronic device comprising:
at least one processor; and
a machine-readable storage medium having stored therein a set of instructions, which instructions when executed by the at least one processor, cause the electronic device to perform operations as a fault manager to:
receive a new set of data samples related to a new fault;
train a new model for the new fault using the new set of data samples;
compare the new set of data samples against a set of previously collected data samples; and
store the new model in an episodic model store, in response to a similarity of the new set of data samples and the set of previously collected data samples failing to meet a first threshold level of similarity.

10. The electronic device of claim 9 further to:
retrieve a set of prior models from the episodic model store; and
compare a similarity of the set of prior models with the new model.

11. The electronic device of claim 10 further to store the new model in the episodic model store, in response to the similarity of the new model and the set of prior models failing to meet a second threshold level of similarity.

12. The electronic device of claim 9 further to store the new set of data samples in a data sample store, in response to the similarity of the new set of data samples being within the first threshold level of similarity with the set of previously collected data samples.

13. The electronic device of claim 11 further to retrain a fault classifier in response to the similarity of the new model and at least one model in the set of prior models meeting the second threshold level of similarity.

14. The electronic device of claim 13 further to update the fault classifier and semantic memory with a retrained fault classifier in response to testing correct fault classifier behavior for the new fault.

15. The electronic device of claim 9 further to:
update a fault type prediction model in a prediction model list to be a retrained fault type prediction model, in response to successful retraining of an existing fault type prediction model; and
update the fault type prediction model in the prediction model list to be a new fault type prediction model, in response to successful training of the new fault type prediction model where the existing fault type prediction model is not found.

16. The non-transitory machine-readable storage medium of claim 8 having further instructions therein that when executed by the processor cause the processor to perform operations further comprising:
retrieving a set of prior models from the episodic model store; and
comparing a similarity of the set of prior models with the new model.

17. The non-transitory machine-readable storage medium of claim 16 having further instructions therein that when executed by the processor cause the processor to perform operations further comprising:
storing the new model in the episodic model store, in response to the similarity of the new model and the set of prior models failing to meet a second threshold level of similarity.

18. The non-transitory machine-readable storage medium of claim 8 having further instructions therein that when executed by the processor cause the processor to perform operations further comprising:
storing the new set of data samples in a data sample store, in response to the similarity of the new set of data samples being within the first threshold level of similarity with the set of previously collected data samples.

19. The non-transitory machine-readable storage medium of claim 17 having further instructions therein that when executed by the processor cause the processor to perform operations further comprising:
retraining a fault classifier in response to the similarity of the new model and at least one model in the set of prior models meeting the second threshold level of similarity.

20. The non-transitory machine-readable storage medium of claim 19 having further instructions therein that when executed by the processor cause the processor to perform operations further comprising:
updating the fault classifier and semantic memory with a retrained fault classifier in response to testing correct fault classifier behavior for the new fault.
